(19) United States
(12) Patent Application Publication
(10) Pub. No.: US 2005/0233035 A1
(43) Pub. Date: Oct. 20, 2005

(54) Microwavable food package having a venting valve

(75) Inventor: Richard Smith, Cambridgeshire (GB)

Correspondence Address: RICHARD M. GOLDBERG, 25 EAST SALEM STREET, SUITE 419, HACKENSACK, NJ, 07601, US

(73) Assignee: BURRALL Limited, Wisbech, Cambridgeshire (GB)

(21) Appl. No.: 10/518,557

(22) PCT Filed: Jul. 4, 2003
(86) PCT No.: PCT/GB03/02881

§ 371 Date: Dec. 22, 2004

(30) Foreign Application Priority Data
Jul. 5, 2002 (GB) 0215603.2
Sep. 24, 2002 (GB) 0222135.6

(51) Int. Cl. A23B 4/00

(52) U.S. Cl. 426/118

(57) ABSTRACT

Apparatus for enabling the alleviation of excess pressure created within a food package as a result of steam generation during cooking and more particularly microwave cooking, includes a product identification band, wrapping member or label (10) which serve to encircle, partially encircle or wrap around a dish format container and/or to identify the contents of the container, the label being formed with a flap or valve through which pressure vents.

This invention relates to a method and apparatus for product packaging. The invention is particularly although not exclusively applicable to packaging for products of the kind which are currently sold with a sleeve-type product identification band, wrapping member or label which serves to encircle, partially encircle, wrap around or identify a product such as a food product or so-called “ready meal” which may be contained in a dish-format container with, for example, sealant film, single layer film, flow wrap and the like covering the container. Other suitable sealant means may also be utilised such as a heat sealed laminate closing the container or rigid polypropylene lids to close the containers.

Such food products or ready meals are cooked, or more often, re-heated in a microwave oven for speed and convenience. The cooking process generates a large amount of heat in the form of steam which, if not allowed to escape, can cause the packaging to rupture, due to the increased pressure created therein by the steam. Such rupturing can cause the contents to spill into the oven and can also compromise the cooking conditions required to safely prepare the food product prior to eating. This problem is often addressed by the user being instructed to randomly pierce the sealant film to allow the steam created to escape, thereby reducing the build up of pressure within the pack.

However, the production of steam within such a wrapped food product can be used to produce steam cooked food products or ready meals. In this case, the random piercing of the sealant film would be inappropriate as the correct cooking conditions may not be maintained, however a sealed container would be liable to rupture with the attendant difficulties as discussed above.

Previous proposals to address this problem have included the provision of a rather complex structure to act as a valve which is inserted into the sealant film. The upper surface of the valve structure is itself covered with a sealant film to prevent contamination. The disadvantages of this arrangement are that it is not unknown for the valve to fail which results in the sealant film rupturing. A further disadvantage of this system is that it is a rather complex mechanism and therefore adds to the cost and complexity of the packaging.

It is an object of the present invention to provide improvements in relation to one or more matters discussed herein or generally.

According to the invention there is provided apparatus for enabling the alleviation of excess pressure created within a food package as a result of steam generation during cooking and more particularly microwave cooking.

In an embodiment of the invention there is provided apparatus for enabling the alleviation of excess pressure created within a food package as a result of steam generation during cooking and more particularly microwave cooking, said apparatus comprises a product identification band, wrapping member or label which serve to encircle, partially encircle, wrap around or be placed on a dish format container and/or to identify the contents of said container and provide information relating thereto. The label comprises a backing layer carrying a release material on one face and a label layer carrying an adhesive on one face to secure the label to the product packaging in due course, said face being adhered to the backing layer and being separable therefrom for application to a package or product in due course.

The product identification band or label is formed with discontinuities in the label layer which may be in the form of cuts, slots, perforations or the like which penetrate the label layer. These discontinuities may take the form of two cuts or slots which converge at a single point, or else be in the form of a single continuous cut such that a “V” shaped cut is formed although any other suitable configuration may be used such as circular oval, square etc. A fold, scored or creased line is provided between the non convergent regions of the cut or cuts such that a triangular region or flap is formed in the label layer therebetween. The arrangement of discontinuities or cuts are not, of course, limited to this particular configuration or arrangement and any suitable combination may be used.

The flap can be lifted or moved separably to the label layer and the fold, scored or creased line serves to impart a “hinge-like” action which assists the lifting of the flap. In addition, this region may also be embossed to a degree such that it is slightly raised from the surface of the main body of the label, this also serves to assist the lifting action of the flap. Furthermore, the embossing serves to provide a cosmetic means of locating the flap when viewing the label.

In a further embodiment of the invention, the regions of discontinuity which take the form of two separate cuts do not converge but are maintained separately such that the general “V” shape is maintained, although any other suitable configuration may be used such as circular oval, square etc, but the cuts are separated by a portion of label material at the point at which they previously converged. The portion of label material acts to connect or “tie” the flap to the label thereby restricting movement of the flap.

In a still further embodiment of the invention, the flap may be formed from a plurality of cuts or slots which, while being arranged in a general “V” shape are separated by a region of label material thereby forming a plurality of ties.

In a still further embodiment of the invention, the region of the label having the fold, scored or creased line which serves to impart a “hinge-like” action when lifting the flap may itself be provided with cut regions or perforations which penetrate the material forming the product identification band or label.

When the food product or so-called “ready meal” contained in a dish-format container, is packaged, the product is sealed in the container using sealant film, a heat sealed laminate, a rigid polypropylene lid or the like is placed over the container and a small aperture such as a slot a cross or “pin prick” is made therein.

The product identification band, wrapping member or label is then applied to and adheres to the packaged product such that the region forming the flap is located over the aperture. Once the label has been applied, the contents of the container remain hermetically sealed despite the regions of discontinuity formed therein as the adhesive provided on the label layer including the flap portion serves to retain this portion in contact with the sealant means.

When the packaged food product is heated in a microwave oven, steam is generated within the package which acts to heat and/or cook the food contained therein. When the amount of steam created within the package reaches a level at which it begins to impinge on the integrity of the sealant film, the pressure will act on the point of least resistance and this will be the aperture made in the sealant film. The steam will begin to move through this aperture as the pressure inside increases. As the aperture is covered by the label and in particular the triangular or flap portion, the steam moving through the aperture will act on the underside of the product identification band, wrapping member or label in this particular region, and the pressure of the escaping steam will cause the adhesive to be this region of the label to be overcome thus permitting the flap portion to lift and act as a valve allowing the steam to vent.

In those embodiments which are formed with ties or retaining tabs, these serve to provide additional restriction to the lifting movement of the flap as a result of pressure caused by escaping steam such that steam is able to vent from beneath the flap as the pressure begins to build and these are then overcome or broken as the pressure increases enabling the flap to lift. An advantage of the retaining ties is that these serve to prevent the flap or valve opening prematurely, for example in the event pressure builds up in the container during storage. In those embodiments of the invention in which the hinged region is formed with discontinuities in the form of cuts or perforations, these serve as further means by which steam may be vented. These embodiments provide means by which different amounts of steam and the attendant pressure created thereby to be retained within different packs.

In a further embodiment of the invention, a range of adhesives of varying strengths may be applied to the product identification band, wrapping member or label for different food products. This will enable different amounts of steam and the attendant pressure created thereby to be retained within different packs before the pressure of steam will overcome the adhesive forces of the label in this area and the flap or valve is activated or lifted.

In a further embodiment of the invention there is also provided a pressure relief valve for a packaging container in the form of a product identification band or label comprising a backing layer carrying a release material on one face and a label layer carrying an adhesive on one face to secure the label to the container, said face being adhered to the backing layer and being separable therefrom for application to a package or product in due course, said label layer being formed with a valve member which, when the label is applied to the container, is disposed over an aperture formed in the container or closure/sealant means therefore. When the food product or so-called “ready meal” contained in a dish-format container, is packaged, the product is sealed in the container using sealant film, a heat sealed laminate, a rigid polypropylene lid or the like is placed over the container and a small aperture such as a slot a cross or “pin prick” is made therein.

The pressure relief valve in the form of a product identification band or label is applied to and adheres to the packaged product such that the valve is located over the aperture. Once the label has been applied, the contents of the container remain hermetically sealed despite the regions of discontinuity formed therein as the adhesive provided on the label layer including the valve portion serves to retain this portion in contact with the sealant means.

When the packaged food product is heated in a microwave oven, steam is generated within the package which acts to heat and/or cook the food contained therein. When the amount of steam created within the package reaches a level at which it begins to impinge on the integrity of the sealant film, the pressure will act on the point of least resistance and this will be the aperture made in the sealant film. The steam will begin to move through this aperture as the pressure inside increases. As the aperture is covered by the label and in particular the valve the steam moving through the aperture will act on the underside of the label in this particular region, and the pressure of the escaping steam will cause the adhesive in this region of the label to be overcome thus permitting the valve to open allowing the steam to vent.

In still further embodiment of the invention there is provided a product identification band, wrapping member or label having adhesive on one face as hereinbefore described in combination with closure means for a container such as a sealant film, a heat sealable laminate, polypropylene lid or the like. The closure means is formed with an aperture therein and when the label and closure means combination are assembled, the flap formed in the label as hereinbefore described is caused to overlie the aperture.

The closure means in combination with the label having a flap which may serve as a valve formed therein is then used in the usual manner to seal a product container. This serves to seal and apply the label to the product in one step.

In a further embodiment of the invention, labels are provided in which the regions of discontinuity may be provided with one or more ties which disrupt the line of the cut thereby providing regions which serve to connect or “tie” the flap to the body of the product identification band are provided in combination with closure means for a container such as a sealant film, a heat sealable laminate, polypropylene lid or the like.

In a still further embodiment of the invention, labels in which the fold, scored or creased line which serves to impart a “hinge-like” action when lifting the flap are provided with cut regions or perforations are provided in combination with closure means for a container such as a sealant film, a heat sealable laminate, polypropylene lid or the like.

In a further embodiment of the invention there is provided a provided a pressure relief valve for a packaging container in the form of a product identification band or label as hereinbefore described in combination with closure means for a container such as a sealant film, a heat sealable laminate, polypropylene lid or the like. The closure means is formed with an aperture therein and when the pressure relief valve and closure means combination are assembled, the valve is caused to overlie the aperture.

In a still further embodiment of the invention there is provided an adhesive self-venting label.

According to a further embodiment of the invention there is provided a packaged product wherein said packaging comprises a dish-like container to retain the product being packaged covered or sealed with a suitable sealant means such as a sealant film, wrap or lid. An aperture is formed in the sealant means and a label or product identification band having a flap, vent or valve means formed therein is placed on the wrapped product to complete the packaging thereon. The label is applied such that the flap or vent is located over the aperture formed in the sealant means.

According to the invention there is also provided a method of facilitating the safe removal of steam wherein during the packaging of a food product or so-called “ready meal” contained in a dish-format container. Said method comprising the step of placing a sealant film over the container, the step of making a small aperture in the sealant film and the further step of applying a product identification wrapping or label having a flap formed therein such that the flap is located over the aperture such that pressure created within the container when the ready meal is heated vents through the flap which acts as a valve.

Embodiments of the invention will now be described with reference to the following illustrative drawings in which:

FIG. 1 shows a diagrammatical plan view of a label as herein before described;

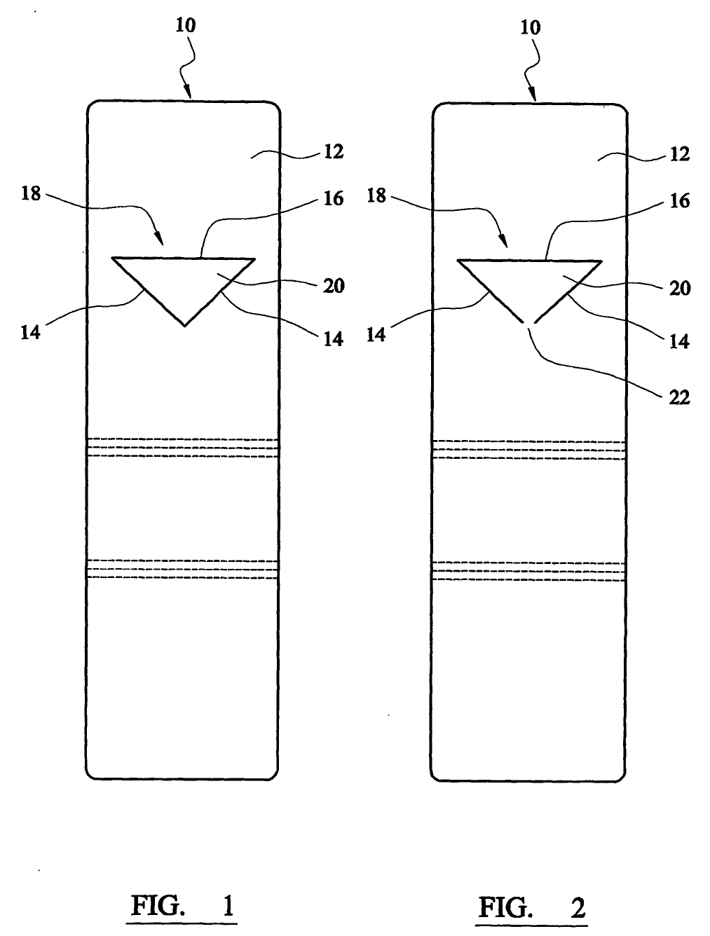

FIG. 2 shows a further embodiment of the label having a tie means;

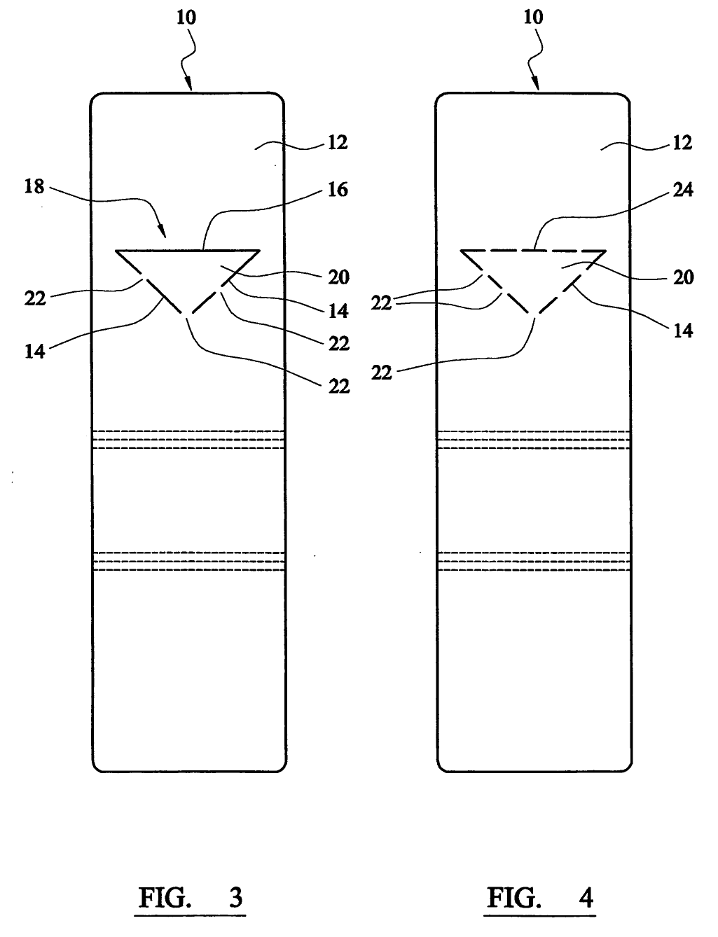

FIG. 3 shows a further embodiment of the label having a plurality of tie means;

FIG. 4 shows a further embodiment of the label;

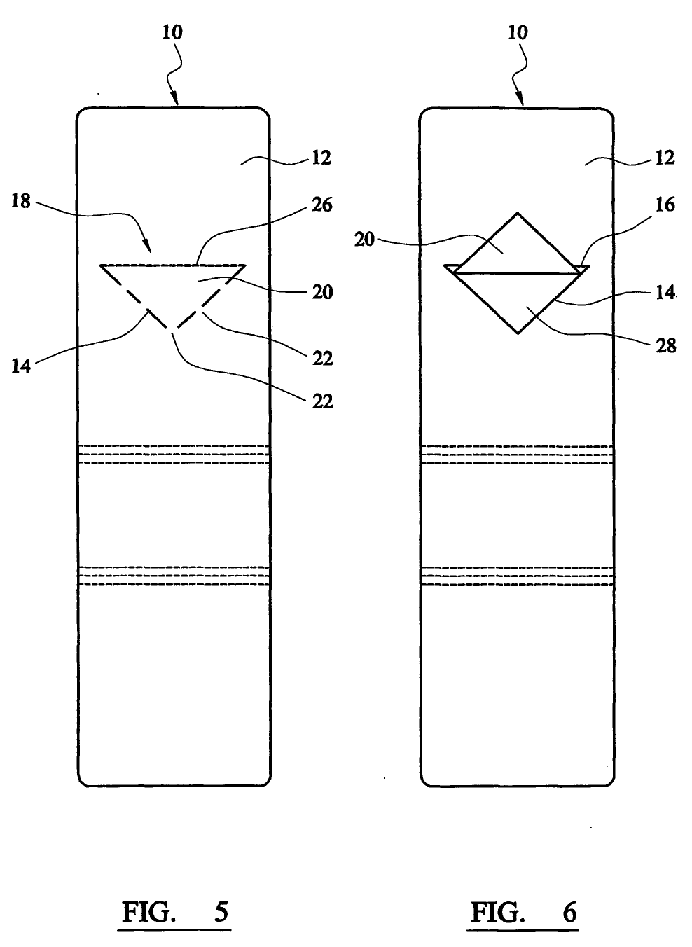

FIG. 5 shows a diagrammatical sectional view of the label of FIG. 1 in combination with closure means; and

FIG. 6 shows a diagrammatical plan view of a label in which the flap or valve member is shown in an open position.

As shown in FIG. 1, said apparatus 10 comprises a product identification band, wrapping member or label 10 which serves to encircle, partially encircle or wraps around a dish format container. The label 10 comprises a backing layer (not shown) carrying a release material on one face and a label layer 12 carrying an adhesive on one face to secure the label to the product packaging in due course, said face being adhered to the backing layer and being separable therefrom for application to a package or product in due course.

The product identification band or label 10 is formed with discontinuities 14 in the label layer 12 which may be in the form of cuts, slots, perforations or the like which penetrate the label layer 12. These discontinuities may take the form of two cuts which converge at a single point, or else be in the form of a single V-shaped cut. A fold, scored or creased line 16 is provided between the non convergent region 18 of the cut or cuts such that a triangular region or flap 20 is formed in the label layer 12 therebetween. In addition, the region 20 may also be embossed 22 to a degree such that it is slightly raised from the surface of the main body of the label 12, this also serves to assist the lifting action of the flap.

When the food product or so-called “ready meal” contained in a dish-format container, is packaged, the product is sealed in the container using sealant film, a heat sealed laminate, a rigid polypropylene lid or the like is placed over the container and a small aperture such as a slot a cross or “pin prick” is made therein.

The product identification band, wrapping member or label 12 is then applied to and adheres to the packaged product (not shown) such that the triangular area 18 is located over the aperture. Once the label 12 has been applied, the contents of the container remain hermetically sealed despite the regions of discontinuity 18 formed therein as the adhesive provided on the label layer including the flap 20 portion serves to retain this portion in contact with the sealant means.

When the packaged food product is heated in a microwave oven, steam is generated within the package which acts to heat and/or cook the food contained therein. When the amount of steam created within the package reaches a level at which it begins to impinge on the integrity of the sealant film, the pressure will act on the point of least resistance and this will be the aperture made in the sealant film. The steam will begin to move through this aperture as the pressure inside increases. As the aperture is covered by the label 10 and in particular the triangular or flap portion 20 the steam moving through the aperture will act on the underside of the product identification band, wrapping member or label in this particular region 12, and the pressure of the escaping steam will cause the adhesive to be this region of the label to be overcome thus permitting the flap portion 20 to lift and act as a valve allowing the steam to vent as shown in FIG. 6.

In those embodiments shown on FIGS. 2, 3, 4 and 5 which are formed with ties or retaining tabs 22 these serve to provide additional restriction to the lifting movement of the flap 20 as a result of pressure caused by escaping steam such that steam is able to vent from beneath the flap 20 as the pressure begins to build and these are then overcome or broken as the pressure increases enabling the flap to lift.

In those embodiments of the invention in which the hinged region is formed with discontinuities in the form of cuts 24 or perforations 26 as shown in FIGS. 5 and 6, these serve as further means by which steam may be vented.

The invention provides a simple, hygienic and cost effective way of providing a safety valve or vent in prepackaged food products to facilitate the safe removal of excess steam created during the cooking/heating process.

1. A member which at least partially wraps around a product packaging of a dish format container, comprising a backing layer carrying a release material on one face and a label layer carrying an adhesive on an opposite face to secure the member to the product packaging, said opposite face being adapted to adhere to the backing layer and being separable therefrom for application to the product packaging, and said member being formed with at least one region of discontinuity in the label layer.

2. A member according to claim 1 wherein said region of discontinuity is in the form of one of a cut, slot, and perforations which penetrate the label layer.

3. A member according to claim 2 wherein the region of discontinuity is in the form of a single shaped cut.

4. A member according to claim 2 wherein said region of discontinuity is in the form of at least two converging cuts.

5. A member according to claim 4 wherein a region of the label layer located between the cuts forms a flap member movable separately from the member.

6. A member according to claim 5 wherein said flap member is provided with one of a fold, scored and creased region which serves to impart a “hinge-like” action assisting movement of the flap member.

7. A member according to claim 4 wherein said cuts are interrupted by portions of label material which act to connect the flap member to said label.

8. A pressure relief valve for a packaging container in the form of a member which at least partially wraps around a product packaging of a dish format container, comprising a backing layer carrying a release material on one face and a label layer carrying an adhesive on an opposite face to secure the member to the product packaging said opposite face being adapted to adhere to the backing layer and being separable therefrom for application to the product packaging, and said member being formed with at least one region of discontinuity in the label layer.

9. A pressure relief valve according to claim 8 wherein said region of discontinuity is in the form of one of a cut, slot, and perforations which penetrate the label layer.

10. A pressure relief valve according to claim 9 wherein the region of discontinuity is in the form of a single shaped cut.

11. A pressure relief valve according to claim 9 wherein said region of discontinuity is in the form of at least two converging cuts.

12. A pressure relief valve according to claim 11 wherein a region of the label layer located between the cuts forms a flap member movable separately from the member.

13. A pressure relief valve according to claim 12 wherein said flap member is provided with one of a fold, scored and creased region which serves to impart a “hinge-like” action assisting movement of the flap member.

14. A pressure relief valve according to claim 11 wherein said cuts are interrupted by portions of label material which act to connect the flap member to said label.

15. A pressure relief valve according to claim 1 in combination with a sealant arrangement for said container.

16. (canceled)

17. A method of facilitating the safe removal of steam from packaging of a food product in a dish-format container, comprising the steps of:
placing a sealant film over the container,
making a small aperture in the sealant film, and
applying a product identification member having a flap formed therein over said sealant film such that the flap is located over the aperture and such that pressure created within the container when the food product is heated vents through the flap which acts as a valve.

18. A packaged product comprising a dish-like container to retain the product covered with a sealant arrangement of one of a sealant film, wrap and lid, with an aperture formed in the sealant arrangement and a member having one of a flap, vent and valve formed therein applied to the sealant arrangement such that the one of the flap, vent and valve is located over the aperture formed in the sealant arrangement.

19. (canceled)

20. A pressure relief valve according to claim 8 in combination with a sealant arrangement for said container.
